(19) United States
(12) Patent Application Publication
(10) Pub. No.: US 2015/0336441 A1
(43) Pub. Date: Nov. 26, 2015

(54) SYSTEMS AND METHODS FOR CONTROLLING A CLIMATE CONTROL SYSTEM

(71) Applicant: GM GLOBAL TECHNOLOGY OPERATIONS LLC, Detroit, MI (US)

(72) Inventors: RUPESH S. KAKADE, MAHARASHTRA (IN); MER PRASHANT, GUJARAT (IN)

(73) Assignee: GM GLOBAL TECHNOLOGY OPERATIONS LLC, Detroit, MI (US)

(21) Appl. No.: 14/282,843

(22) Filed: May 20, 2014

(51) Int. Cl. B60H 1/00

(52) U.S. Cl. CPC B60H 1/0075

(57) ABSTRACT

Methods and systems for controlling a climate control system of a vehicle are provided. In one embodiment, a method comprises: determining a solar azimuth angle curve associated with point of interest; determining at least one intersection point between the azimuth angle curve and at least one line that defines at least one edge of a transparent element of the vehicle; determining whether the point of interest is shaded or not shaded based on the at least one intersection point; and automatically controlling the climate control system based on the determination of whether the point of interest is shaded or not shaded.

### TECHNICAL FIELD

The technical field generally relates to climate control systems, and more particularly relates to automatic climate control systems which compensate by changing air flow, air temperature and/or air distribution for solar exposure of the occupants based on whether a point of interest, for example, a solar sensor is shaded or not shaded.

### BACKGROUND

Automatic climate control systems are becoming more prevalent in vehicles. Such systems attempt to regulate the temperature inside the vehicle to a temperature set by the user. Generally these climate control systems determine a temperature and an airflow and distribution required to regulate the temperature based upon a lookup table which has to be tuned based upon iterative vehicle tests. The tuning can be subjective and may not accurately control the temperature. In addition, ambient conditions may vary and can impact the automated control of the temperature inside the vehicle.

Accordingly, it is desirable to provide improved methods and systems for controlling the climate. It is further desirable to provide improved methods and systems for controlling the climate based on solar exposure. Furthermore, other desirable features and characteristics of the present invention will become apparent from the subsequent detailed description and the appended claims, taken in conjunction with the accompanying drawings and the foregoing technical field and background.

SUMMARY

Methods and system for controlling a climate control system of a vehicle are provided. In one embodiment, a method comprises: determining a solar azimuth angle curve associated with point of interest; determining at least one intersection point between the azimuth angle curve and at least one line that defines at least one edge of a transparent element of the vehicle; determining whether the point of interest is shaded or not shaded based on the at least one intersection point; and automatically controlling the climate control system based on the determination of whether the point of interest is shaded or not shaded.

In another embodiment, a climate control system for a vehicle is provided. The climate control system includes a heating system, an air conditioning system, and a control module. The control module is communicatively coupled to at least one of the heating system and the air conditioning system. The control module: determines a solar azimuth angle curve associated with point of interest; determines at least one intersection point between the azimuth angle curve and at least one line that defines at least one edge of a transparent element of the vehicle; and determines whether the point of interest is shaded or not shaded based on the at least one intersection point.

### DESCRIPTION OF THE DRAWINGS

The exemplary embodiments will hereinafter be described in conjunction with the following drawing figures, wherein like numerals denote like elements, and wherein:

FIG. 1 is a functional block diagram of an exemplary vehicle, in accordance with various embodiments;

FIG. 2 is a partial perspective view of a vehicle, in accordance with various embodiments;

FIG. 3 is a partial perspective view of an interior of a vehicle, in accordance with an embodiment;

FIGS. 4 and 5 are flow charts illustrating methods for controlling a climate control system, in accordance with various embodiments; and

FIGS. 6 and 7A-7B illustrate the calculations involved in determining whether a point of interest is exposed to solar rays, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

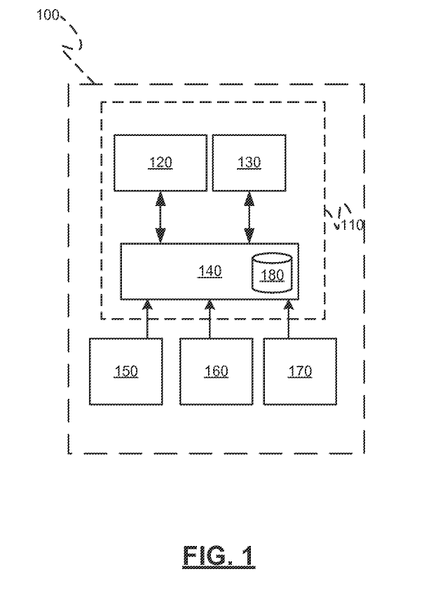

With reference to FIG. 1, a block diagram of an exemplary vehicle 100 is shown in accordance with exemplary embodiments. As can be appreciated, the vehicle 100 is shown as one non-limiting example of the various embodiments of the present disclosure, as the present disclosure is applicable to any enclosure having transparent elements, such as glass, and a climate control system.

In the example of FIG. 1, the vehicle 100 may be an automobile, an aircraft, a spacecraft, a watercraft or any other type of vehicle that utilizes heating and/or cooling systems. The vehicle 100 includes a climate control system shown generally at 110. The climate control system 110 includes an air conditioning system 120 to provide cooled air to the interior of the vehicle 100 and a heating system 130 to provide warmed air to the interior of the vehicle 100. The air conditioning system 120 and heating system 130 of the climate control system 110 may generally include, but are not limited to, at least one air delivery motor, at least one blower motor, at least one heat exchanger, a compressor, at least one thermal expansion valve, and at least one coolant pump, and a variety of piping and exhaust vents to provide cooled air to the interior of the vehicle 100.

The climate control system 110 further includes a control module 140 for controlling the climate control system 110, as discussed in further detail below. As can be appreciated, the control module 140 may be shared by other systems in the vehicle 100 or may be specific to the climate control system 110.

The control module 140 communicates with one or more input/output devices 150. The I/O devices 150 may include, for example a display device and one or more associated input devices. The display device displays a user interface for permitting user control of one or more features of the climate control system 110. For example, the user interface may allow a user to set a different temperature for different zones of the vehicle 100, or set a different temperature between different occupants, such as a driver and a passenger. A user may interact with the user interface via one or associated input devices such as, but not limited, control switches, control knobs, touch sensors, keypads, or any other input device. As can be appreciated, the I/O devices 150 may be mounted on a dashboard (or other location) of the vehicle 100 or may be provided on an auxiliary device (i.e., a smart phone or other smart device) that communicates with the vehicle 100.

The control module 140 receives inputs from one or more solar sensors 160. The solar sensors 160 may be disposed in various locations of the vehicle 100 and may include a single-cell solar sensor and/or a multi-cell solar sensor. The single-cell solar sensor includes, for example, one photo-diode which outputs a voltage corresponding to an intensity of solar rays from the sun hitting the single-cell solar sensor. The multi-cell solar sensor includes multiple photo-diodes, each outputting a voltage corresponding to an intensity of solar rays from the sun hitting the respective photo-diode in the multi-cell solar sensor. A comparison between the outputs of the each photo-diode of the multi-cell solar sensor can be used to determine a solar elevation (otherwise known as zenith) and an azimuth angle.

In various embodiments, the control module 140 further receives input from a global positioning system (GPS) receiver 170. GPS is a space-based satellite navigation system that provides location and time information in all weather conditions, anywhere on or near the Earth where there is an unobstructed line of sight to four or more GPS satellites. The GPS receiver 170, based upon the signals from the GPS satellites, can calculate an accurate location of the vehicle 100. Using the location of the vehicle 100 and time information, a solar elevation angle, and/or a solar azimuth angle can be determined.

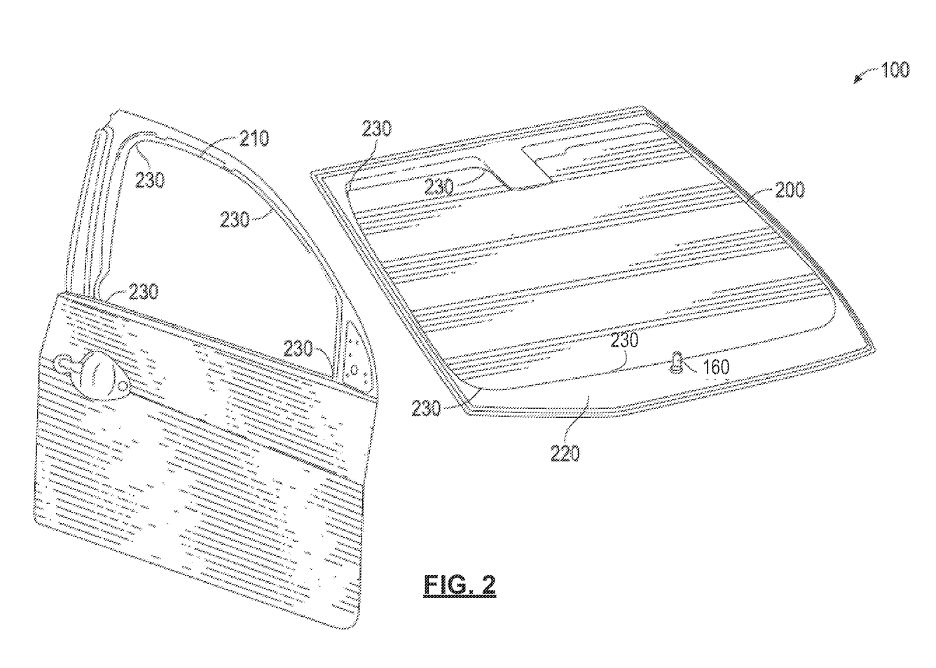

In various embodiments, the control module 140 includes a data storage device 180 (or alternatively communicates with a remote storage device (not shown)). The data storage device 180 may be any non-volatile memory, including, but not limited to, a hard disk drive, flash memory, read only memory, or optical drive. The data storage device 180 stores vehicle geometry data. In various embodiments, the vehicle geometry data includes a relative position of transparent elements of a vehicle such as a windshield, side windows, a rear window, a sunroof, and a convertible roof relative to a component within the vehicle such as a solar sensor, a seat, or other surface within the vehicle 100. For example, FIG. 2 is a partial perspective view of the vehicle 100, in accordance with an exemplary embodiment. The vehicle includes a windshield 200 and at least one side window 210. The solar sensor 160 is positioned on a dashboard 220 of the vehicle 100. The data storage device 180, illustrated in FIG. 1, stores vehicle geometry data associated with the windshield 200 and the at least one side window 210. For example, the data storage device 180 may store a series of multi-dimensional coordinate points 230. For example, each multi-dimensional coordinate point 230 may be measured relative to the position of the solar sensor 160. In other words, the position of the solar sensor 160 may be (0, 0, 0) and each other multi-dimensional coordinate point 230 is measured relative therefrom.

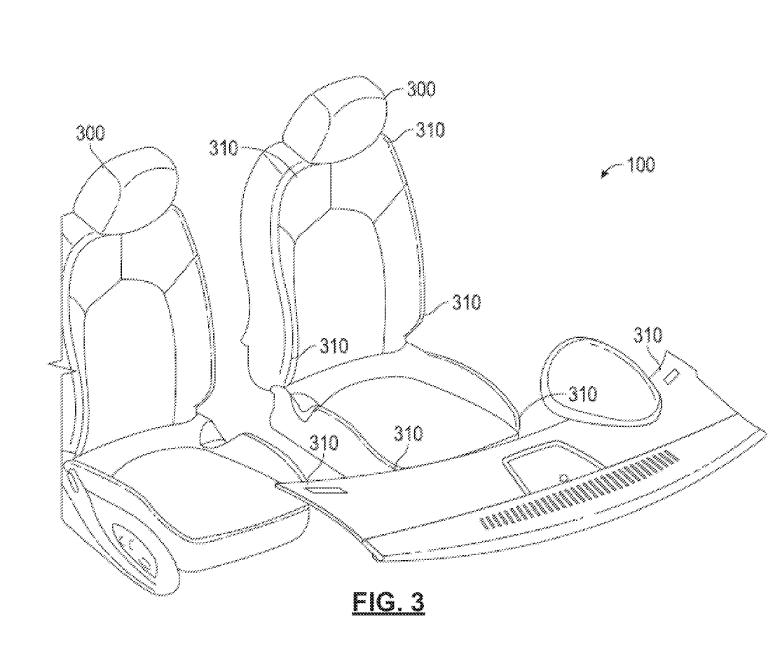

In another example, FIG. 3 is a partial perspective view of an interior of the vehicle 100, in accordance with an exemplary embodiment. The interior of the vehicle 100 includes multiple seats 300. As with the windshield and other windows of the vehicle 100, multi-dimensional coordinate points 310 corresponding to the position of the seats 300 relative to the position of the solar sensor 170 are determined. In one embodiment, for example, the multi-dimensional coordinate points 310 of the seats 300 may be variable. The seats 300 of the vehicle may be movable in multiple dimensions. In other words, the seats 300 could be brought forwards or backward, raised or lowered. An angle of the seat back relative to a seat bottom may also be variable. The seats 300 could be adjusted manually or electronically via a power seat system (not illustrated). In one embodiment, for example, the position of the various components of the seat 300 may be tracked by the power seat system. In other embodiments, for example, position sensors or cameras could track the position of the seats 300. The position of the seats 300 could be reported to the control module 140 directly, or stored in the data storage device 180 (FIG. 1).

With reference back to FIG. 1, as will be discussed in further detail below, the control module 140 receives the various signals and determines if a point (such as point stored in the data storage device 180 defining a location of a solar sensor 160 or a vehicle seat 300) or an arbitrary surface is shaded from solar rays. The control module 140 determines whether the location is shaded from solar rays based on a comparison of a current solar elevation angle to a range of elevation angles. As will be discussed in more detail below, the current solar elevation angle may be determined by the control module 140 based on the GPS information from the GPS system 170 or may be received from the solar sensor 160. As will be discussed in more detail below, the range of elevation angles may be determined by the control module 140 based on an intersection of a solar azimuth curve and line segments corresponding to the edges of the transparent feature of the vehicle 100.

In one example, the control module 140 determines whether the solar sensor 160 is shaded. If it is determined that the solar sensor 160 is shaded, the control module 140 then determines whether an occupant seated in the seat 300 of the vehicle 100 is shaded. If the occupant is not shaded, the control module 140 compensates for the exposure to solar rays by adjusting a temperature, a flow rate, and a distribution of air from the duct outlets so that the thermal comfort of the occupant is improved. In various embodiments, the control module 140 compensates for the exposure based on a cumulative moving average of solar intensity.

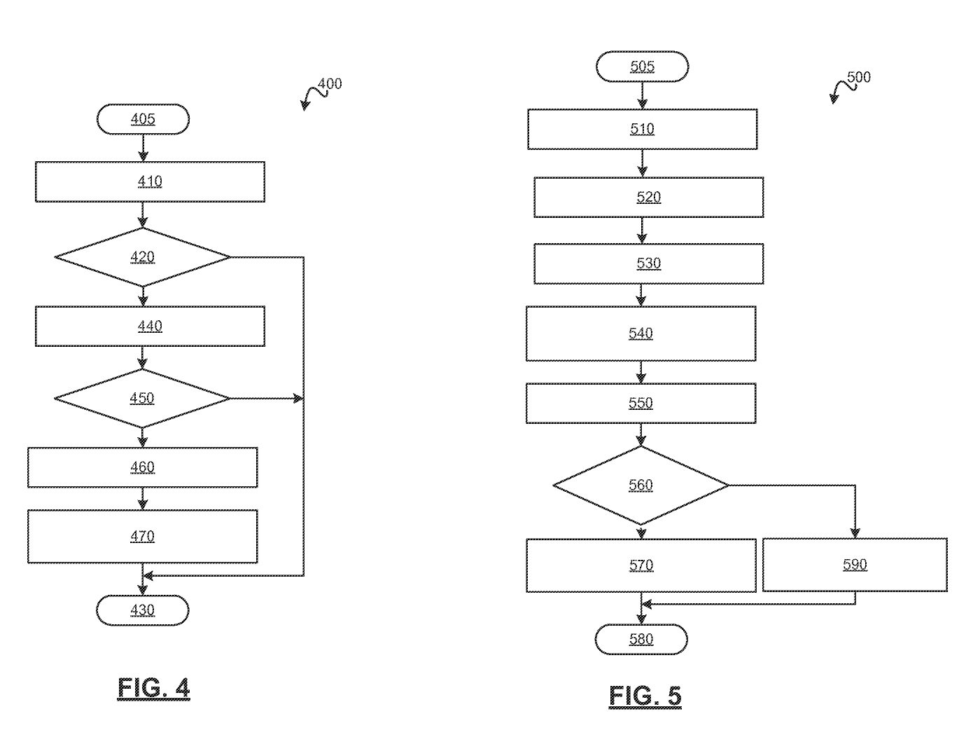

With reference now to FIGS. 4 and 5 and with continued reference to FIGS. 1-3, flowcharts are shown of methods 400 and 500 for controlling a climate control system, in accordance with various embodiments. The methods 400 and 500 can be implemented in connection with the vehicle 100 of FIG. 1 and can be performed by the control module 140 of FIG. 1, in accordance with various exemplary embodiments. As can be appreciated in light of the disclosure, the order of operation within the method is not limited to the sequential execution as illustrated in FIGS. 4 and 5, but may be performed in one or more varying orders as applicable and in accordance with the present disclosure. As can further be appreciated, the methods of FIGS. 4 and 5 may be scheduled to run at predetermined time intervals during operation of the vehicle 100 and/or may be scheduled to run based on predetermined events.

FIG. 4 is a flowchart of a method for controlling the climate control system 110 based on compensation values. As depicted in FIG. 4, the method 400 may begin at 405. It is determined whether the solar sensor 160 is shaded for a particular elevation angle Θ at 410 (as will be discussed in more detail with regard to the method 500 of FIG. 5). If it is determined that the solar sensor 160 is not shaded for the particular elevation angle Θ at 420, no compensation is performed (or alternatively other compensation methods are performed) and the method may end at 430.

If, however, it is determined that the solar sensor 160 is shaded for the particular elevation angle Θ at 420, it is determined whether the occupant is shaded at 440 (as will be discussed in more detail with regard to the method 500 of FIG. 5). If, the occupant is shaded at 450, no compensation is performed (or alternatively other compensation methods are performed) and the method may end at 430. If, however, it is determined that the occupant is not shaded at 450, compensation values that take in to account the shaded solar sensor 160 is estimated based on a cumulative moving average of the solar intensity at 460. Thereafter, the climate control system 110 is controlled based on the compensation values at 470 and the method may end at 430.

FIG. 5 is a flowchart of a method 500 for determining whether a point (either the solar sensor 160 or the occupant seated in the seat 300) is shaded. The method 500, for example, corresponds to steps 410 and 440 in FIG. 4, in accordance with various embodiments. As depicted in FIG. 5, the method may begin at 505.

The solar elevation angle θ (also referred to as the zenith angle) and the solar azimuth angle φ are received or determined at 410 with respect to a vehicle coordinate system that is a spherical coordinate system having a particular point (point of interest) as the origin (e.g., either the solar sensor 160 for step 410 or a point of the seat 300 for step 440). The solar elevation angle θ corresponds to an angle of the traced solar ray relative to a horizon (i.e., the ground) and a zenith. The solar ray azimuth angle φ corresponds to an angle of the solar ray relative to a reference vector, such as a vector corresponding to the vehicle driving direction.

A constant azimuth angle curve is calculated for the given solar azimuth angle φ at 520 with respect to a vehicle coordinate system having a point of interest (e.g., either the solar sensor 160 for step 410 or a point of the seat 300 for step 440) as the origin. A constant azimuth angle curve corresponds to a half disc of lines traced towards the origin (point of interest) with an elevation angle of lines ranging from −90° to +90°. Solar azimuth angle is determined based on the GPS information or is received from the solar sensor.

The boundary edges of the transparent elements such as the windshield 200 and the side window 210 halve are determined based on the four coordinate points 230 stored for each of the windshield 200 and the side window 210 in the data storage device 180 at 530. For example, each boundary edge may be defined by two of the data points 230 associated with the edge. The three coordinates (x, y, z) of the coordinate points 230 associated with the edge are translated from the Cartesian coordinate system to a spherical coordinate (r, θ, φ) system using the following relations:

tan θ=P_{—}z/P_{—}x, and

tan φ=P_{—}y/P_{—}x.

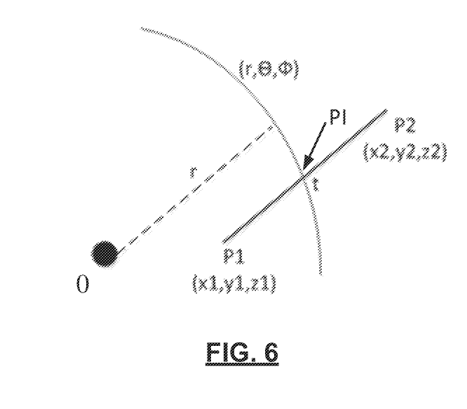

Intersection points of the azimuth angle curve with each of the boundary edges are then determined at 540. For example, as shown in FIG. 6 an intersection of a line defined by the spherical coordinates P1-P2 (edge of the windshield 200 or side window 210) and the constant azimuth angle curve defined by (r, θ, φ) can be determined by solving the three equality relations:

x₁+t(x₂−x₁)=r cos θcos φ,

y₁+t(y₂−y₁)=r cos θsin φ, and

z₁+t(z₂−z₁)=r sin θ

for t, which is the relative weighing of an intersection point PI on the line P1-P2. The value of t can be determined as:

$$t = \frac{{y}_{1} - {x}_{1} tan φ}{( {x}_{2} - {x}_{1} ) tan φ - ( {y}_{2} - {y}_{1} )} .$$

The value of t is then used to calculate an intersection point. The value of t is computed for each line that is defined by the points associated with each edge of the windshield 200 halve and the side window 210. For example, t is computed for the four edges of the side window 210, and t is computed for the three edges of the windshield 200. The value oft is then evaluated to see if the corresponding intersection point PI falls on the line between points P1 and P2. If t is greater than or equal to zero and less than or equal to one (0<=t<=1), then it is determined that the intersection point PI is on the line between P1 and P2, which defines the edge of the windshield 200 or the side window 210, and that value oft is used to calcuate an intersection point PI.

With reference back to FIG. 5, at 550, a range of elevation angles for which the solar sensor is exposed to solar rays is determined using the saved intersection points. For example, by again solving the three equality relations:

x₁+t(x₂−x₁)=r cos θcos φ,

yᵢ+t(y₂−y₁)=r cos θsin φ, and

z₁+t(z₂−z₁)=r sin θ

for the elevation angle θ provides:

$$θ = {tan}^{- 1} \{ ( \frac{1}{{x}_{2} - {x}_{1}} ) ( ( {z}_{2} - {z}_{1} ) cos φ + ( \frac{{z}_{1} {x}_{2} - {x}_{1} {z}_{2}}{{y}_{1} {x}_{2} - {y}_{2} {x}_{1}} ) ( ( {x}_{2} - {x}_{1} ) sin φ - ( {y}_{2} - {y}_{1} ) cos φ ) ) \} .$$

Here (x1, y1, z1) and (x2, y2, z2) are obtained for the origin (point of interest) and the intersection point PI. The elevation angle is therefore calculated for a given intersection point PI and a known azimuth angle from a constant azimuth angle curve.

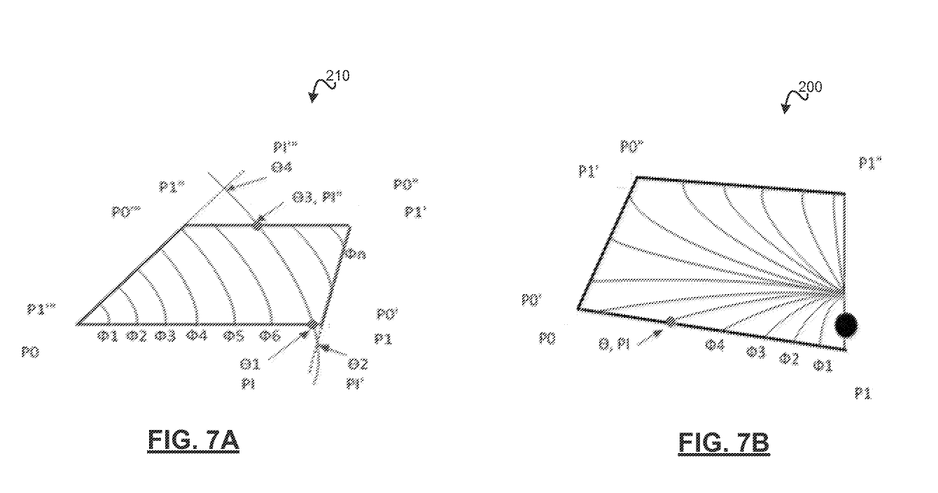

Using this relation, the elevation angles θ are determined for the intersection points associated with t. For example, as shown in FIG. 7A, the elevation angle θ1 is computed for the first edge of the side window 210 having the intersection point PI, and the elevation angle θ3 is computed for the second edge of the side window 210 having the intersection point PI″. An elevation angle maximum θmax is set to the maximum of θ1 and θ3; and an elevation angle minimum θmin is set to the minimum of θ1 and θ3. The range is then defined as the elevation angles between the elevation angle minimum θmin and the elevation angle maximum θmax.

In another example, as shown in FIG. 7B, the elevation angle θ is computed for the first edge of the windshield 200 halve having the intersection point PI. An elevation angle minimum θmin is set equal to this elevation angle θ. The range is then defined as the elevation angles less than the elevation minimum θmin.

With reference back to FIG. 5, the actual solar elevation angle (computed in step 510) is then compared to the ranges to determine if the solar sensor 160 is or is not exposed to the solar ray at 560. For example, if the solar elevation angle θ is within the range defined by the minimum θmin and the maximum θmax associated with the side windshield 210, and/or the solar elevation angle θ is outside of the range defined by the minimum θmin associated with the windshield 200 halve (e.g., greater than or equal to the minimum) at 450, it is determined that the solar sensor 160 or the occupant (depending on which point is used in step 510 as the origin) is not shaded and is exposed to solar rays at 570. Thereafter, the method may end at 580.

If, however, the solar elevation angle θ is outside of range the defined by the minimum θmin and the maximum θmax associated with the side windshield 210 or the solar elevation angle θ is within the range defined by the minimum θmin associated with the windshield 200 halve (e.g., less than the minimum θmin) at 560, it is determined that the solar sensor 160 or the occupant (depending on which is used in step 510) is shaded and is not exposed to solar rays at 590. Thereafter, the method may end at 580.

As can be appreciated, the computations and evaluations of the method shown in FIG. 5 can be performed for all of the transparent elements or certain of the transparent elements of the vehicle 100, and thus the invention is not limited to the present example of using the windshield 200 and the side window 210.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a climate control system of a vehicle, comprising:
determining a solar azimuth angle curve associated with point of interest;
determining at least one intersection point between the azimuth angle curve and at least one line that defines at least one edge of a transparent element of the vehicle;
determining whether the point of interest is shaded or not shaded based on the at least one intersection point; and
automatically controlling the climate control system based on the determination of whether the point of interest is shaded or not shaded.

2. The method of claim 1, further comprising determining a solar azimuth angle, and wherein the determining the solar azimuth angle curve is based on the solar azimuth angle.

3. The method of claim 1, further comprising determining a range based on the at least one intersection point, and wherein the determining whether the point of interest is shaded or not shaded is based on the range.

4. The method of claim 3, further comprising determining a solar elevation angle for the at least one intersection point, and wherein the determining the range is based on the solar elevation angle.

5. The method of claim 3, wherein the determining the range comprises determining a minimum solar elevation angle from a first intersection point.

6. The method of claim 5, wherein the determining the range comprises determining a maximum solar elevation angle from a second intersection point.

7. The method of claim 3, wherein the determining whether the point of interest is shaded is based on whether a solar elevation angle is not within the range.

8. The method of claim 1, wherein the point of interest is a solar sensor of the vehicle.

9. The method of claim 1, wherein the point of interest is an occupant of the vehicle.

10. The method of claim 1, further comprising computing a compensation value based on the determination of whether the point of interest is shaded, and wherein the automatically controlling the climate control system is based on the compensation value.

11. The method of claim 10, wherein the computing the compensation value is based on a cumulative moving average of solar intensity.

12. A climate control system for a vehicle, comprising:
a heating system;
an air conditioning system; and
a control module communicatively coupled to at least one of the heating system and the air conditioning system, wherein the control module:
determines a solar azimuth angle curve associated with point of interest;
determines at least one intersection point between the azimuth angle curve and at least one line that defines at least one edge of a transparent element of the vehicle; and
determines whether the point of interest is shaded or not shaded based on the at least one intersection point.

13. The system of claim 12, wherein the control module determines a range based on the at least one intersection point, and determines whether the point of interest is shaded or not shaded based on the range.

14. The system of claim 13, wherein the control module determines a solar elevation angle for the at least one intersection point, and determines the range based on the solar elevation angle.

15. The system of claim 13, wherein the control module determines the range by determining a minimum solar elevation angle from a first intersection point.

16. The system of claim 15, wherein the control module determines the range by determining a maximum solar elevation angle from a second intersection point.

17. The system of claim 12, wherein the at least one line defines an edge of a windshield of the vehicle.

18. The system of claim 12, wherein the at least one line defines an edge of a side window of the vehicle.

19. The system of claim 12, wherein the point of interest is a solar sensor of the vehicle.

20. The system of claim 12, wherein the point of interest is an occupant of the vehicle.

21. The system of claim 12, wherein the control module computes a compensation value based on the determination of whether the point of interest is shaded, and automatically controls the climate control system based on the compensation value.
